(19) United States
(12) Patent Application Publication
(10) Pub. No.: US 2007/0294640 A1
(43) Pub. Date: Dec. 20, 2007

(54) User interface and computer software product and a method for implementing the same

(75) Inventors: Paavo Eskelinen, Oulu (FI); Juhani Hannu, Oulu (FI)

Correspondence Address: BIRCH STEWART KOLASCH & BIRCH, PO BOX 747, FALLS CHURCH, VA, 22040-0747, US

(73) Assignee: HEAD INHIMILLINEN TEKIJA OY, Oulu (FI)

(21) Appl. No.: 11/653,276

(22) Filed: Jan. 16, 2007

Related U.S. Application Data
(60) Provisional application No. 60/773,327, filed on Feb. 15, 2006.

(30) Foreign Application Priority Data
Jan. 20, 2006 (FI) 20065040

(51) Int. Cl. G06F 3/048

(52) U.S. Cl. 715/835

(57) ABSTRACT

The invention relates to a user interface of a player of a mobile device (10). The user interface comprises graphical icons (16) representing the functions of the player, of which icons only the ones that can be performed in the current mode of operation of the player are shown on the display (11) of the device. Each of the graphical icons shown on the display is associated with one of the keys (12, 13, 14) of the device. In addition, the user interface comprises, in at least two languages, operating instructions, which are saved in the memory of the device as a text file. The invention also relates to a method and computer program product for implementing the user interface of a player.

The invention relates to an audio/video user interface of a small, mobile device, and a computer software product and a method for implementing the user interface.

Personal data processing and data transfer devices have become smaller year by year, and thereby they have also become mobile. The term often used in this connection is mobile device. Mobile devices like this include, for example, terminal devices of various cellular networks, PDA devices (Personal Digital Assistant) and so-called palm computers. Audio or video recordings can nowadays also be reproduced in these devices. However, the existing programs, which can be used for audio and video reproduction and which are called players hereinafter, are often rather clumsy with regard to their use. One reason for this is the complicated user interface structure of prior art players, and another reason is the fact that the user interface of the player is for certain parts dependent on the software solutions used in the hardware platform of the device being used.

The software platforms of mobile devices typically include specific software components intended for the user interface implementations of the applications, which offer complete, partial solutions for the communication between the user and the device. These components have been designed to function in certain versions of a certain operating system, which restricts their usability with regard to the operating system alone. In addition to this, the structures that support the operating system may differ so much from each other in practice that the user interface component of a device series cannot be directly transferred as such to another device supporting the same operating system.

An attempt is always made to implement the software components of the hardware platform on as general a level as possible. Hence their execution speed, i.e. the time of reacting to a measure by the user, may in some cases be too long from the user's point of view, i.e. using them may feel uncomfortably slow.

In prior art players, their operation is often controlled by means of various menus or virtual windows. Preparing the player for operation and starting the playing may require the use of several consecutive menus. The consecutive menus and the execution time required by them increase the starting delay.

The use of menus is always related to the user's language. With regard to the user, it is desirable that the menus of the device, as well as the menus of the player, are implemented in a language understood by the user. If this is not the case, the use of the device or the player included in it may prove to be at least difficult, if not impossible. For taking the operating language of the device into consideration, it is necessary to add a special language control or localisation mechanism in the software platforms of the prior art mobile devices, and using it may be laborious and cumbersome.

It is an objective of the invention to provide a user interface of a player to be utilized in a mobile device and a method implementing it, by which the language control problem related to the use of the player can be avoided. It is also an objective of the invention to speed up the reaction of the player to commands, which are given to the player by the user by means of the user interface.

The objectives of the invention are achieved by a solution in which the operation of the player is controlled by an autonomous user interface application implemented with graphical icons, which is almost independent of the structures of the hardware platform and the software utilized in it or the component technology used in the device. The use of graphical icons in the control and operation of the player simplifies the language control arrangement of the player greatly.

The invention has the advantage that the user interface is almost independent of the resources and user interface structures offered or required by the mobile device.

The invention also has the advantage that the small size of the user interface software, 20 to 40 kB, enables usability in the present cellular network terminal devices of the 2G-3G generations and the terminal devices of the future generations.

Furthermore, the invention has the advantage that the functions of the player during operation are independent of the user's language, which minimizes the resources required for the language control. Hence it is possible to maintain tens of different language versions simultaneously in the same device with a memory of a few kilobytes.

Yet another advantage of the invention is that a new language version can be added quickly and easily, and it does not require using the complicated language control system of the mobile device.

Yet another advantage of the invention is that due to the passing of the structures tied to the operating system of the platform of the mobile device, the program can be started and used quickly.

Yet another advantage of the invention is that the simple graphical appearance makes the user interface understandable and clear, because most of the images/icons used for graphical expression are internationally used and well known.

Yet another advantage of the invention is the fact that the user interface minimizes the use of keys, because almost all the functions are controlled by one direction key.

Yet another advantage of the invention is that the user interface program is updated automatically, when required.

The user interface according to the invention is characterized in that the user interface comprises as nearly independent of the operating system:
an image read and write code for saving graphical icons describing the functions of the player into the memory of the device and for retrieving them from the memory,
a display updating code for updating the graphical icons shown on the display to correspond to the functions that are possible for the player at the current moment, and
a key code interpreter for starting the function after a key has been pressed for implementing the function of the graphical icon, which is associated with the key, the depression of which has been identified.

The computer software product according to the invention for implementing the user interface is characterized in that the computer software product comprises, as nearly independent of the operating system:
an image read and write code for saving graphical icons describing the functions of the player into the memory of the device and for retrieving them from the memory,
a display updating code for updating the graphical icons shown on the display to correspond to the functions that are possible for the player at the moment, and
a key code interpreter for starting the function after a key has been pressed, in accordance with the function of the graphical icon which is associated with the key the depression of which has been identified.

The method according to the invention for implementing the user interface of a player is characterized in that the operation of the player is controlled by a user interface, which is almost independent of the operating system of the mobile device, by which
only the functions of the player which can be selected to be executed in the current operating mode of the player are shown on the display of the device as graphical icons,
a selectable function of the player is executed by activating a key of the device associated with a graphical icon shown on the display, and
after the selected operation, the graphical icons shown on the display are updated to correspond to the new mode of operation of the player.

Some advantageous embodiments of the invention are presented in the dependent claims.

The basic idea of the invention is the following: The user interface is based on the use of only one display window, a few icons and one text file. The text file contains several language versions, and it can be edited quickly and easily by ordinary text editing programs before it is packed into the desired file form. The user interface software of the player according to the invention can be easily applied to the terminal devices of the present and the future due to its small size and the independence of its device platform. The user interface of the player is implemented as an independent portion, which does not require any special features of the user interface level of the software platform of the device. Therefore, it can be easily transferred between different versions of the operating system and also from one operating system to another.

The user's operations are controlled by only a few icons, which occur on the display of the device during use only in the situations in which the measures indicated by the icons shown are possible. In other words, only the icons that are capable of active operation are shown. The icons according to the operating system according to the invention are divided into two subgroups: function icons and information icons. Function icons indicate a function related to the use of the device, which is implemented by pressing the device reference key associated with the icon. The function associated with the function icon can advantageously be implemented by pressing one of the following: one of the two programming keys or the direction key with five functions. Information icons indicate a piece of information related to the current operation of the device; for example, the sound volume icon has a numeric field or a graphical field, in which a number or the height of a graphical column indicates the volume selected during the reproduction.

In the following, the invention will be described in more detail. Reference will be made to the accompanying drawings, in which

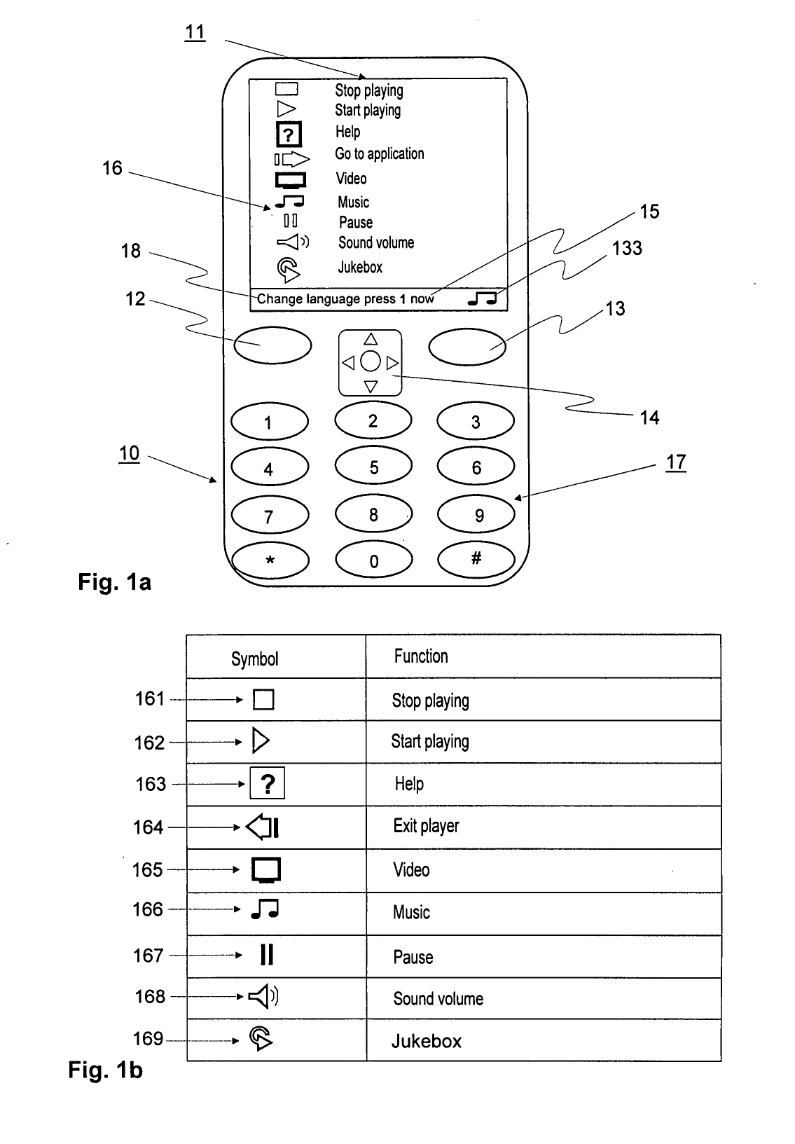

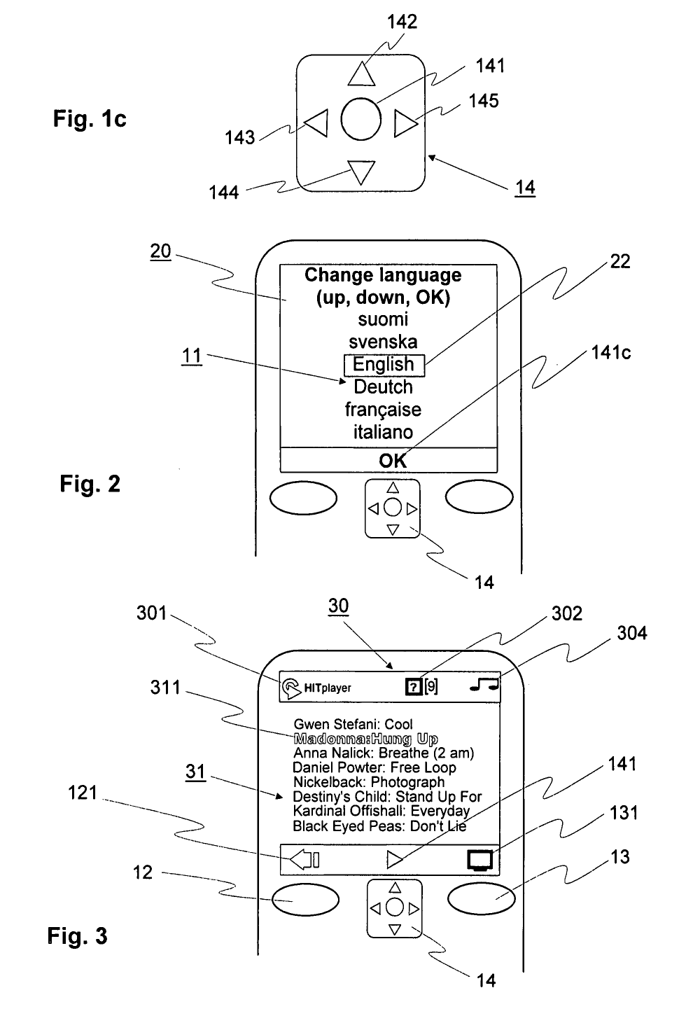

FIG. 1a shows a display according to the invention in a terminal device of a cellular network by way of example,

FIG. 1b shows the graphical icons used in the control of the player by way of example,

FIG. 1c shows the direction key utilized in the invention by way of example,

FIG. 2 shows the installation menu of the player according to the invention by way of example,

FIG. 3 shows the selection of a piece of music in the player according to the invention by way of example,

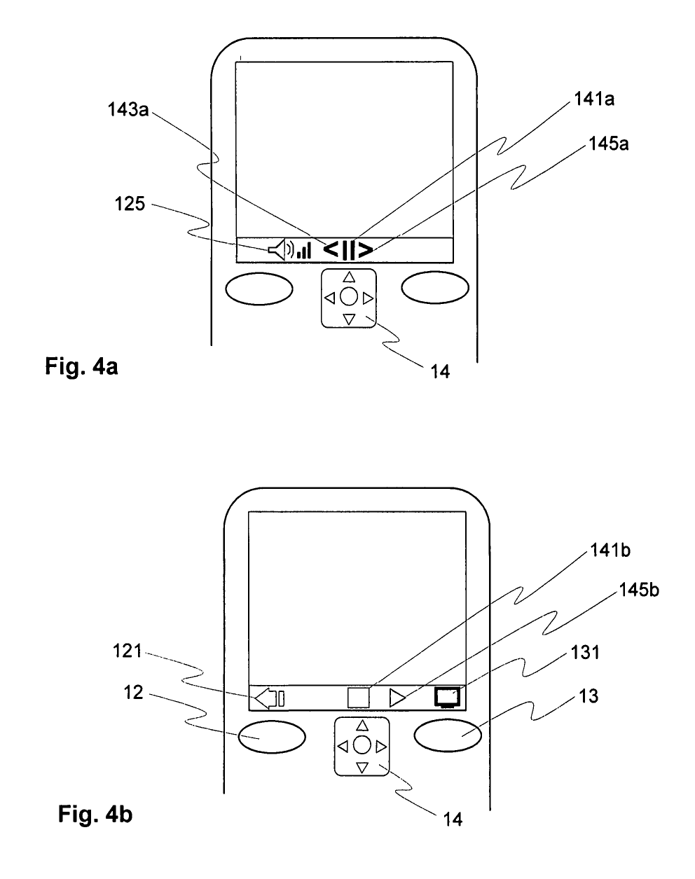

FIG. 4a shows examples of the functions that can be selected while playing a piece of music,

FIG. 4b shows examples of the functions that can be selected when the player that performed the playing of the music is in the pause mode,

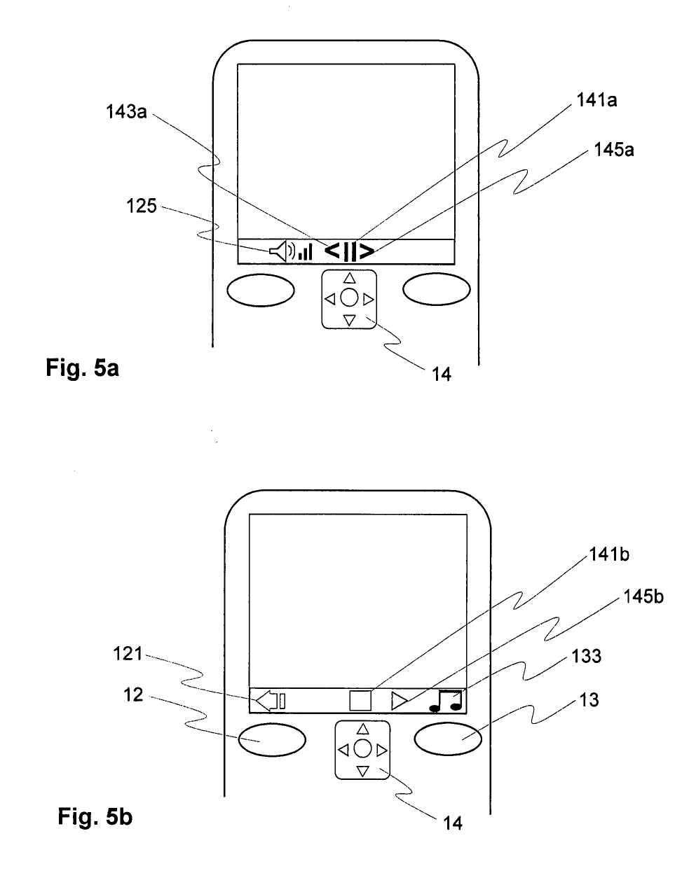

FIG. 5a shows examples of the functions that can be selected while playing a video recording,

FIG. 5b shows examples of the functions that can be selected when the player that performed the playing of the video recording is in the pause mode,

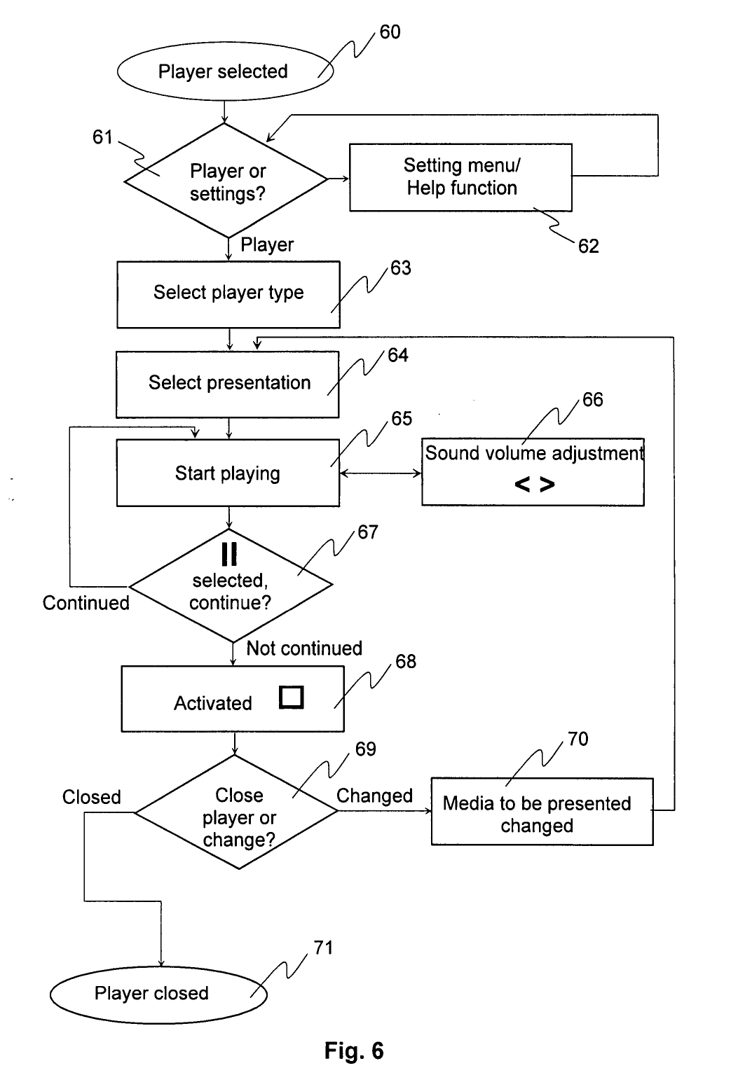

FIG. 6 shows the main steps of the method implementing the user interface according to the invention as an exemplary flow chart, and

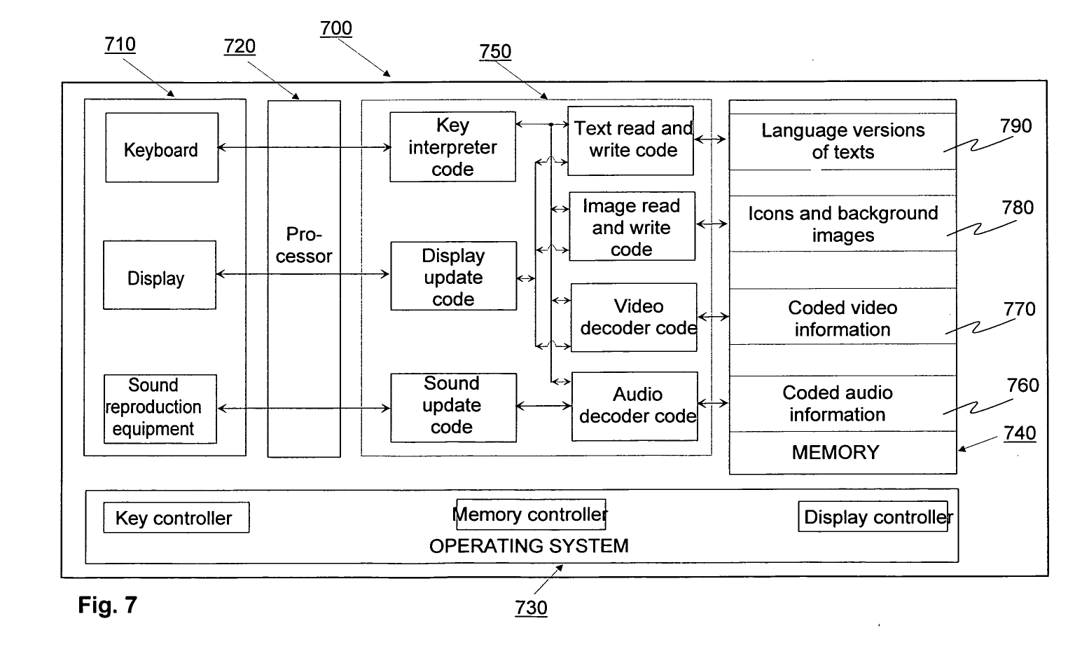

FIG. 7 shows an example of a terminal device in which the user interface according to the invention has been implemented.

FIG. 1a shows an exemplary terminal device 10 of the cellular network. It is obvious to a person skilled in the art that the invention can also be utilized in other mobile devices than the terminal device according to FIG. 1a.

The terminal device 10 of FIG. 1a comprises a prior art keyboard 17, two prior art programming keys 12 and 13, a direction key 14 and a display 11. In the example of FIG. 1a, the Help page 110 of the user interface according to the invention is shown on the display 11 of the terminal device 10. The Help page 110 comprises the graphical icons 16 to be utilized in the user interface according to the invention, and their short descriptions in the language last selected by the user. The user interface bar 15 is seen on the display 11 of the terminal device as the lowest. On the left edge of the user interface bar 15, reference number 18 indicates for a while, as text, a possibility to move to the language selection menu of the user interface by pressing the numerical key 1 of the device. If the numerical key 1 is not pressed at the determined time, the message 18 disappears from the display 11. Alternatively, the user can directly switch to using the music player, which is shown by the icon 133. Switching to the music player is combined with the programming key 13, by the pressing of which the operation can be implemented.

FIG. 1a does not show (for simplifying the drawing) the information bar advantageously located in the upper part of the display 11, which is explained in connection with FIG. 3 and which contains information icons indicating functions that are possible in the Help state, and the keys 17 of the device 10 associated with them.

The meanings of the icons 16 shown in FIG. 1a are explained in FIG. 1b. The playing of the player is stopped by a key connected with the icon according to Ref. 161. Similarly, the playing of the player is started by a key connected with the icon according to Ref. 162. The pressing of the key connected with the icon according to Ref. 163 brings the Help page to the display of the device. The pressing of the key connected with the icon according to Ref. 164 ends the player application. The icon of Ref. 165 indicates the video playing mode and the icon of Ref. 166 indicates the music playing mode. The pressing of the key connected with the icon of Ref. 167 temporarily stops the playing of the player, i.e. it is a so-called pause key. From this state, the player can either be started again from the point where it was stopped by the playing key, Ref. 162, or stopped entirely by the stopping key, Ref. 161. Information icon 168 indicates the sound volume of the player and information icon 169 indicates whether the Jukebox function has been started. If the Jukebox function has not been activated, the icon 169 is not shown on the user interface bar 15.

FIG. 1c shows a prior art direction key 14. With this key 14, it is possible to implement five different functions independent of each other in one operation mode of the player, depending on the way the direction key 14 is pressed. Altogether, including different modes of operation, it is possible to implement eight different functions with the direction key 14 in different modes of operation of the player. In the example of FIG. 1c, the key 14 has been provided with four arrow symbols, Refs. 142 to 145, and one circular symbol 141. Each symbol 141 to 145 shown corresponds to one of the five functions implemented with the key 14.

The function related to the circular symbol 141 is implemented by pressing the direction key 14 at the centre directly towards the body of the device. In FIG. 1c, the function associated with the upward pointed arrow 142 is implemented by pressing the edge of the direction key 14, which is closest to the arrow 142. In FIG. 1c, this means pressing the upper edge of the direction key 14. Correspondingly, the function associated with arrow 143 is implemented by pressing the left edge of the direction key 14 in FIG. 1c. The function associated with the arrow 144 is implemented by pressing the lower edge of the direction key 14, and the function associated with the key 145 by pressing the right edge of the direction key 14 in FIG. 1c. The function associated with each symbol 141-145 of the direction key 14 is determined on the basis of the mode in which the player according to the invention is. When the player is switched from one mode of operation to another, the functions associated with the direction key 14 may also change.

FIG. 2 shows an example of the installation display 20 of the user interface according to the invention, which is shown on the display screen of the device 10 when the user interface application according to the invention is installed in the device 10. The description is shown uppermost on the display: Change language. The alternatives possible for the user are shown below it in brackets: up, down or OK. The user of the device can step on the display from one line to another preferably with the up key 142 and the down key 144 of the direction key 14. Examples of the language selections are shown in FIG. 2: Finnish, Swedish, German, French and Italian. Each of the languages is written in the language in question. When the cursor 22 is at the desired language, the user presses the function key 14, which is connected with the icon OK, Ref. 141c. When the language selection has been performed, the device is directed to the Help page (FIG. 1), in which the icons 16 according to the invention are presented in the desired language. It is possible to install more language versions in the device 10 than can be fitted on the display 11 of the device. In that case, the activation of the up/down function of the function key 14 rolls onto the display more languages, which could not be fitted on the display in the starting situation. In an advantageous embodiment of the invention, the names of the languages have been replaced by the flag of the country corresponding to the language.

FIG. 3 shows an example of a situation in which the user of the device has selected the playing of music. Some of the pieces of music 31 to be played are shown on the display of the device. Because the size of the display is limited, there may be more of the pieces of music to be played than the ones that can be shown on the display. Pressing the left edge 143 of the direction key 14 brings the pieces of music on the previous page visible on the display, and pressing the right edge 145 of the direction key 14 brings the pieces of music on the next page visible on the display. By pressing the upper edge 142 of the direction key 14, the user can move upward on the list of music, and by pressing the lower edge 144 of the direction key 14, the user can move downward on the list of music. In the example of FIG. 3, the piece of music 311 selected is started by pressing the direction key 14 at the centre, which is associated with an icon 141 indicating starting. By pressing the programming key 13, it is possible to switch from the music list directly to the corresponding video list. This switching operation is described by the icon 131 on the lower right edge of the user interface bar 15. The icon according to Ref. 121 indicates the possibility of exiting the player according to the invention by pressing the programming key 12.

FIG. 3 shows an example of the information bar 30 according to the invention. In the example of FIG. 3, it comprises the logo 301 of the player, the icon 302 of the Help page and beside it number 9 in brackets. When the numerical key 9 of the device is pressed, the device switches to the Help page according to the invention (FIG. 1).

In an advantageous embodiment, the information bar 30 may also include at least one icon 169 of the functions implemented by the numerical key 0 of the device (not shown in FIG. 3). By the icon according to Ref. 169, it is indicated to the user that when the numerical key 0 of the device is pressed, the player switches to the Jukebox mode. In this mode, the player plays all the pieces of music in its memory one after another. When the Jukebox function has been activated in the playing mode, an icon appears in the information bar to indicate that the Jukebox function has been activated. The information bar 30 may advantageously also include a download activation icon # (not shown in FIG. 3). Then the download operation associated with the icon # is started by pressing the # button of the device.

In an advantageous embodiment of the invention, the piece of music to be played can also be selected by the numerical keys 17 of the device. Advantageously, only eight pieces of music are shown on the display 11 of the device 10, in which case the piece topmost on the list is selected by the numerical key 1, for example, and the piece lowest on the display by the numerical key 8. In an advantageous embodiment of the invention, the numerical key by the pressing of which the playing of the piece is started is also shown beside each recording that can be selected.

The functions assigned to the numerical keys 0 and 9 and the key # have been presented above. The * key is reserved for a function to be taken into use later.

FIGS. 4a and 4b present the playing of music in different steps by way of example. The user interface according to the invention is characterized in that only the icons that can be utilized or that provide information necessary for the user at the current moment are presented. In FIG. 4a, the piece of music is just being played. In an advantageous embodiment of the invention, it can be indicated by a music playing icon in the information bar 30. In the playing mode, the piece of music can only be stopped by pressing the direction key 14 at the centre. This possibility is indicated in the user interface bar 15 by the icon 141a. Then the player switches to the so-called pause mode, in which the playing has been temporarily stopped, but from which it can be directly continued forward.

On the left edge of the user interface bar 15, there is the sound volume icon 125. The current volume of the sound reproduction is indicated beside it by vertical columns. The volume level of the music can be raised by pressing the right edge of the direction key 14. This possibility is indicated in the user interface bar 15 by the icon 145a. The volume level can be decreased by pressing the left edge of the direction key 14. This possibility is indicated in the user interface bar 15 by the icon 143a.

In the example of FIG. 3, growing bars are used to indicate the volume level. It is obvious to a person skilled in the art that the sound volume can also be indicated in other simple ways.

FIG. 4b shows an example of a situation in which the player has been switched to a so-called pause mode by the function described in FIG. 4a. The playing of the music has then been temporarily stopped. The icons of the user interface bar 15 are updated as follows. The icon 141b for stopping the playing is directly above the direction key 14. It is activated by pressing the direction key 14 at the centre. A play resume icon 145b is added to the user interface bar on the right side of the direction key 14. The playing can be resumed by pressing the right edge of the direction key 14. When the programming key 12 is pressed, the use of the player is ended and the player application according to the invention is exited. This is indicated by the icon 121. By the programming key 13, the user can switch directly to the video list indicated by the icon 131, and from it to the video playing mode by starting the playing of one video by the direction key.

FIGS. 5a and 5b present the playing of a video in different steps by way of example. In FIG. 5a, the video recording is being played. In an advantageous embodiment of the invention, it can be indicated by a video playing icon. In the playing mode, the video recording can only be stopped by pressing the direction key 14 at the centre. This possibility is indicated in the user interface bar 15 by the icon 141a. Then the player switches to the so-called pause mode, in which the video playing has been temporarily stopped, but from which it can be directly continued forward.

The sound volume icon 125 is on the left edge of the user interface bar also in this playing mode. The volume level of the video can be increased by pressing the right edge of the direction key 14. This possibility is indicated in the user interface bar 15 by the icon 145a. The volume level can be decreased by pressing the left edge of the direction key 14. This possibility is indicated in the user interface bar 15 by the icon 143a.

FIG. 5b shows an example of a situation in which the player has been switched to the so-called pause mode by the operation described in FIG. 5a. The presentation of the video has then been temporarily stopped. The icons of the user interface bar 15 are updated as follows. The icon 141b for stopping the playing is directly above the direction key 14. It is activated by pressing the direction key 14 at the centre. A video play resume icon 145b is added to the user interface bar on the right side of the direction key 14. The playing of the video can be resumed by pressing the right edge of the direction key 14. When the programming key 12 is pressed, the player is stopped completely and the player application according to the invention is exited. This is indicated by the icon 121. By the programming key 13, the user can switch to the list of music, and from it to the music playing mode by starting the playing of one piece of music by the direction key

FIG. 6 shows an exemplary flow chart of the main steps of the operation of the player according to the invention, when the player according to the invention has already been installed in the device 10. The features of the invention presented in FIGS. 1 to 5b are referred to in the description. In step 60, the user selects the player application according to the invention from the menu or display according to the operating system of the device. Then the control of the device 10 is completely transferred from its operating system to the application according to the invention.

In step 61, the player according to the invention is started from the music playing mode, from which the user can choose to move to the Help page or the video list or select a piece of music from the list of music by the direction key and start the playing of the music. From this mode, the user can switch to the setting menu to change the language of use by pressing the numerical key 1 of the device, whereby the player switches to the language selection display (FIG. 2), or download media files from a suitable server by the # key.

If the user has selected the Help page, he can switch the player from the Help page directly to the music playing mode by pressing the programmable key 13. This function is indicated by the icon 113. When the functions of step 62 have been performed, the user returns to step 61. If the option “player” is selected now, the next step is 63, in which the user is first offered a music player for use according to FIG. 3. However, the user can switch the player to the video playing mode by pressing the programming key 13. The function is indicated by the icon 131. When the playing mode of the player has been selected, the presentation to be played is selected in step 64. The selection can advantageously be carried out in the manner described in connection with the description of FIG. 3.

When the player is started in step 65, the display of the player corresponds to the presentation according to FIG. 4a or 5a, including the icons. The playing step 65 is associated with the sound volume adjustment, which is carried out in a separate, parallel step 66, which does not stop the recording being played.

In step 67, the playing of the recording has been interrupted by the pause key 141a. Then the user can either continue the presentation of the recording by pressing the right edge of the direction key 14, which implements the continuation of the playing indicated by the icon 145b, or he may stop the playing completely by pressing the direction key 14 at the centre. Then the user selects the ending function according to the icon 141b in step 68.

In step 69, the user can stop using the player by selecting the function corresponding to the icon 121 by pressing the left programming key 12. Then the player according to the invention ends up in step 71, in which the player is closed. Then the control of the device 10 has been returned to the operating system of the device.

Alternatively, the user can press the icon button 13 of the alternative playing method. If audio playing is stopped by selecting the video playing icon 131, the player switches to the video playing mode. After this, the video to be presented is selected again in step 64. If video playing is stopped by selecting the audio playing icon 133, the player switches to the audio play mode. The music recording to be played is selected again in step 64.

The retrieval of the recordings of the player according to the invention and the language selections take place in step 62. When the user has installed the software in the device and the software has not yet been registered, the user is offered the possibility to become registered. If the user wants to become registered, the software according to the invention asks the user to write the information required for the registration, after which the information is automatically copied to the registration server and the software is started. If the user does not want to become registered in this situation, the performance of the registration is interrupted. If the user has downloaded into his device recordings offered freely, which contain the functions of the player according to the invention without registration, they can be played with the player without actual registration.

When the software is started for the first time, the selection of the language versions is shown on the display in step 62. When the language of operation has been selected, the operating instructions are shown on the display 11 automatically. Because the use of the entire software is controlled by only a few icons, the operating instructions can usually be fitted on one display screen, which makes starting the use of the software easier than normally.

The structure of the operating instructions is also straightforward. There is only a short, descriptive text at each icon. The efficiency of the implementation of the application according to the invention for different devices and operating languages on one hand, and the fast learning and easiness of use on the other hand are manifested here. At each new time of starting the application in step 61, there occurs on the display screen for a short time a reference to the key of the device, by the pressing of which the operating instructions can be shown, when desired. This key is advantageously the numerical key 9 of the device. By pressing the numerical key 9, the user can always get the operating instructions of the player according to the invention onto the display screen. At the same time, the icon of the playing mode from which the user came to the Help page is updated above the right programming key 13 on the lower part of the display. When the programming key 13 is pressed, the recording according to the selected playing mode is started.

The application program contains only a very small amount of text information related to the use, which is in no way dependent on the software structures of the device, and therefore it is possible to make different language versions quickly with a conventional text processing program. The additional storage space required by the texts is very small. Typically, the memory requirement of one language version is of the order of 200 bytes, and hence an embodiment containing 15 different language versions only requires 2.8 kilobytes of additional memory, which can further be decreased close to 1 kilobyte. Table 1 shows an example of an English and a Swedish text file, which describes the operating instructions of the player.

TABLE 1
An example of the operating instruction text file of the player

| No. | English | Swedish |
|---|---|---|
| 1. | Stop playing, [symbol] | Stoppa uppspelningen |
| 2. | Start playing, [symbol] | Starta uppspelningen |
| 3. | Exit application, [symbol] | Gå ut ur tillämpningen |
| 4. | Go to application, [symbol] | Gå till tillämpningen |
| 5. | Video, [symbol] | Video |
| 6. | Music, [symbol] | Musik |
| 7. | Sound volume, [symbol] , [symbol] | Ljudstyrka |
| 8. | Page change, [symbol] | Sidbyte |
| 9. | Jukebox, press key 0, [symbol] | Jukebox, tryck på knappen 0 |
| 10. | Downloading, press key #, [symbol] | Nedladdning, tryck på |
| | | knappen # |
| 11. | Operating instructions | Bruksanvisning |
| 12. | Log in to the to services | Logga in i tjänsterna |
| 13. | User ID | Användarnamn |
| 14. | Password | Lösenord |
| 15. | Select language, [symbol] | Välj språk |
| 16. | Connection | Förbindelse |
| 17. | OK | OK |
| 18. | Failed | Misslyckades |
| 19. | Video slow motion | Video långsam återgivning |
| 20. | Pause, [symbol] | Paus |
| 21. | Create a playing list | Skapa en uppspelningslista |
| 22. | My playing lists | Egna uppspelningslistor |
| 23. | Back | Tillbaka |
| 24. | Select | Välj |
| 25. | Produced by Hitmedia | Producerat av Hitmedia |
| | International. | International |

In addition to the keys mentioned above, two other ordinary keys found in each mobile device, i.e. the numerical key 0 and the special character key #, are utilized in the user interface according to the invention.

By the numerical key 0, the Jukebox function is activated and closed in the playing of the recording. In the Jukebox function, the pieces of music on the playing list are played one after another, in a selected or random order, if the playing is not interrupted. The 0 key is functional only during the starting of the player in step 61 when, as it is pressed for the first time, the corresponding icon preferably appears in the information bar 30 in the upper part of the display 11 of the device.

After the playing has been started, this Jukebox icon remains on the display, and the playing switches always to the next piece of music on the playing list when the previous one has stopped. If the playing is interrupted, the program switches either to the play waiting mode, step 67, or the start ready mode, step 64. If the 0 key is pressed for a second time, the Jukebox function is closed, and the corresponding Jukebox icon 0 disappears from the display 11 of the device.

The pressing of the # key establishes a connection to a content provider server (not shown in the drawings), from which, after identification, the user can browse and download into his device 10 the desired music and video recordings. These functions are preferably performed by means of the direction key 14 in a manner described earlier. In this connection, the content provider server advantageously also gets information of the version of the software the user has. If there is a newer version on the server, the user may give permission to automatic updating of his software, if he so wishes.

During the whole server connection, there is a return icon 121 above the right programming key 13, from which the user can at any time return to the program state preceding this step by pressing this key 13.

The 9 and # keys are active only in the setting menu mode, step 62.

There may be one or more of the information icons according to the invention, depending on the configuration of the application. The information icon used to indicate the sound volume has been described above as an example. Other such information icons (not shown in the figures) are, for example, an icon showing the time passed during the playing of a piece of music, an icon showing the time left of the playing, an icon showing the name of the piece of music being played, an icon showing the list number of the piece of music being played, an icon for establishing a connection to the server, an icon for downloading the content, an icon for software update etc.

FIG. 7 shows an example of a mobile device 700. The device 700 comprises the user interface components 710. The user interface components 710 comprise at least a keyboard used for controlling the functions of the device 700, which advantageously includes at least the numerical and function keys mentioned in connection with the description of FIG. 1a. The user interface components 710 of the device 700 also include a suitable display device and suitable sound reproduction means. The processor of the device 700 is represented by Ref. 720. The operating system 730 of the device 700 comprises a key controller, a memory controller and a display controller. The user interface application according to the invention utilizes the operating system 730 of the device 700 minimally, because the user interface application according to the invention directly controls the memory 740 of the device 700, the sound reproduction devices and the key functions by utilizing the processor 720.

The user interface application according to the invention is implemented by the user interface block 750, which advantageously comprises a key interpreter code, sound update code, display update code, text read and write code and image read and write code. In an advantageous embodiment of the invention, the user interface block 750 also includes a specific video decoder code part and an audio decoder code part. Other prior art commercial products can also be utilized as video and audio decoders.

The text read and write code part controls the reading/writing of different language version recordings 790 saved in the memory 740. The image read and write code part controls the reading/writing of icons and background images 780 saved in the memory 740. The video decoder code part controls the use of the coded video information 770 saved in the memory 740. The coded video information 770 has advantageously been saved in a form which can only be reproduced by a device utilizing a certain video decoder code. The audio decoder part controls the use of the coded audio information 760 saved in the memory 740. The coded audio information 760 has advantageously been saved in a form which can only be reproduced by a device utilizing a certain audio decoder code.

The user interface block 750 also includes a key interpreter code, which interprets which instruction/function is to be performed when a certain key is pressed. The function caused by the pressing of the key always depends on the state in which the player according to the invention is when the key is pressed.

The user interface block 750 also includes a display update code part, by which the icons, texts, background images and video image coming to the display are controlled. The display update code part changes, for example, the icons on the display to correspond to the functions that are possible in the current mode of operation of the player. The user interface block 750 also includes a sound update code part, which controls the sound reproduction of the recording coming from the audio decoder, which is to be played.

The size of the user interface application is of the order of 20-40 kilobytes. The application can advantageously be saved either in the separate memory 740 of the device 700 or the memory belonging to the processor 720 (not shown in FIG. 7). If the device 700 is a terminal device of the cellular network, the user interface application can also be saved in the SIM card (Subscriber Identity Module) fastened to the device. Due to its small size, the user interface application according to the invention can be easily moved from one device to another. The movability is also improved by the fact that the user interface application according to the invention does not necessarily require the software components of the actual operating system of the device for its operation.

Some advantageous embodiments of the method and device according to the invention have been described above. The invention is not limited to the solutions described above. For example, other graphical symbols/icons than those presented in the examples described above can also be utilized in the invention. Similarly, in the devices which do not have a five-function direction key, certain keys can be defined to implement the functions of the direction key. The colour and size of the icons can also vary. In addition, the inventive idea can be applied in many different ways within the scope defined by the attached claims.

1. A user interface (750) of a player of a mobile device (10, 700),
which mobile device comprises
keys (12, 13, 14, 17) for controlling the operation of the player, and
a display (11) for presenting the mode of the player,
characterized in that the user interface (750) comprises, as nearly independent of the operating system (730) of the device (10, 700)
an image read and write code for saving graphical icons (161-169) representing the functions of the player into a memory (740) of the device (10, 700) and for retrieving them from the memory,
a display update code for updating the graphical icons (161-169) shown on the display (11) of the player to correspond to the functions that are possible for the player at the moment, and
a key interpreter code for starting a function after a key (12, 13, 14) has been pressed for implementing the function of the graphical icon, which is associated with the key, the depression of which has been identified.

2. The user interface according to claim 1, characterized in that it also comprises
a text file read and write code for saving and reading of a text file, and
the operating instructions of the graphical icons (161-169) saved in the memory (740) of the device (10, 700) as a text file in at least two languages.

3. The user interface according to claim 1, characterized in that it comprises graphical icons representing the functions of the player: stop playing (161), start playing (162), Help function (163), exit application (164), video playing (165), music playing (166), temporary interruption of playing (167), sound volume increase and sound volume decrease (168) and Jukebox (169).

4. The user interface according to claim 3, characterized in that the functions related to the following graphical icons have been arranged to be performed by one of the functions associated with the direction key (14): stop playing (161), start playing (162), temporary interruption of playing (167), sound volume increase or sound volume decrease (168).

5. The user interface according to claim 3, characterized in that the functions related to the following icons have been arranged to be performed with one of the programming keys (12, 13) of the device (10): exit application (164), select video playing (165) and select music playing (166).

6. A computer program product for providing a graphical user interface for a player of a mobile device (10, 700), characterized in that the computer program product comprises, as nearly independent of the user interface of the device (10, 700)
an image read and write code for saving graphical icons (161-169) representing the functions of the player into a memory (740) of the device (10, 700) and for retrieving them from the memory,
a display update code for updating the graphical icons (161-169) shown on the display (11) of the player to correspond to the functions that are possible for the player at the moment, and
a key interpreter code for starting a function after a key (12, 13, 14) has been pressed, in accordance with the function of the graphical icon which is associated with the key the depression of which has been identified.

7. The computer program product according to claim 6, characterized in that it also comprises
a text file read and write code for the saving and reading of a text file, and
the operating instructions of the graphical icons (161-169) saved in the memory (740) of the device (10, 700) as a text file in at least two languages.

8. The computer program product according to claim 6, characterized in that it comprises computer program code means for presenting the following graphical icons representing the functions of the player on the display (11) of the device (10): stop playing (161), start playing (162), Help function (163), exit application (164), video playing (165), music playing (166), temporary interruption of playing (167), sound volume increase and sound volume decrease (168) and Jukebox (169).

9. The computer program product according to claim 8, characterized in that it comprises computer program code means for performing the functions related to the following graphical icons by one of the functions associated with the direction key (14): stop playing (161), start playing (162), temporary interruption of playing (167), sound volume increase or sound volume decrease (168).

10. The computer program product according to claim 8, characterized in that it comprises computer program code means for performing the functions related to the following graphical icons with one of the programming keys (12, 13) of the device (10): exit application (164), select video playing (165) and select music playing (166).

11. A method for using a player of a mobile device (10, 700) which mobile device comprises keys (12, 13, 14, 17), a processor (720), a memory (740) and a display (11),
characterized in that the operation of the player is controlled by a user interface, which is nearly independent of the operating system (730) of the mobile device (10, 700), by which
only the functions of the player which can be selected to be performed in the current operating mode of the player are shown on the display of the device (10, 700) as graphical icons (161-169),
a selectable operation of the player is performed by activating a key (12, 13, 14) of the device (10, 700) associated with a graphical icon (161-169) shown on the display (11), and
after the selected operation, the graphical icons (161-169) shown on the display are updated to correspond to the new mode of operation of the player.

12. The method according to claim 11, characterized in that the following functions of the player are indicated on the display (11) of the device (10) with graphical icons (161-169): stop playing (161), start playing (162), Help function (163), exit application (164), video playing (165), music playing (166), temporary interruption of playing (167), sound volume increase and sound volume decrease (168) and Jukebox (169).

13. The method according to claim 12, characterized in that the functions related to the following graphical icons are performed by one of the functions associated with the direction key (14): stop playing (161), start playing (162), temporary interruption of playing (167), sound volume increase or sound volume decrease (168).

14. The method according to claim 12, characterized in that the functions related to the following graphical icons are performed with one of the programming keys (12, 13) of the device (10): exit application (164), select video playing (165) and select music playing (166).

15. The method according to claim 11, characterized in that the operating instructions of the player are saved in the memory (740) of the device (10, 700) as a text file in at least two languages, one of which is selected as the language in which the instructions are presented.

16. The method according to claim 15, characterized in that the language of the operating instructions has to be selected in connection with the installation of the player in order to make the player ready for operation.

17. The method according to claim 16, characterized in that the language of the operating instructions that was installed in connection with the installation of the player is changed after the starting of the player by switching the player to the language selection mode again by pressing the numerical key 9.

18. The method according to claim 11, characterized in that the functions of the player according to the graphical icons are controlled by one or two keys (14, 12 or 13) of the device (10).

19. The method according to claim 11, characterized in that the Jukebox of the player is activated or deactivated by pressing the numerical key 0.
